(19) United States
(12) Patent Application Publication
(10) Pub. No.: US 2025/0110002 A1
(43) Pub. Date: Apr. 3, 2025

(54) METHOD FOR PREDICTING THE PRESSURIZATION RATE OF OIL TANKS AND COMPUTER-READABLE STORAGE MEDIA

(71) Applicants: PETRÓLEO BRASILEIRO S.A. – PETROBRAS, Rio de Janeiro (BR); UNIVERSIDADE FEDERAL DO RIO DE JANEIRO - UFRJ, Rio de Janeiro (BR)

(72) Inventors: Fabio Cesar DIEHL, Rio de Janeiro (BR); Pedro Henrique Thompson FURTADO, Rio de Janeiro (BR); Tiago Silva Miranda LEMOS, Rio de Janeiro (BR); Jose Carlos De Jesus LIMA, Rio de Janeiro (BR); Jose Carlos COSTA DA SILVA PINTO, Rio de Janeiro (BR); Victor De Backer MOURA, Santos (BR); Thiago Koichi ANZAI, Rio de Janeiro (BR); Rafael Marinho SOARES, Rio de Janeiro (BR); Saul Simoes NETO, Santos (BR); Rodrigo Calado SUZUKI, Santos (BR)

(21) Appl. No.: 18/903,278

(22) Filed: Oct. 1, 2024

(30) Foreign Application Priority Data
Oct. 3, 2023 (BR) 1020230204295

(51) Int. Cl. G01L 19/00

(52) U.S. Cl. CPC G01L 19/0092

(57) ABSTRACT

The present disclosure relates to a method for predicting the pressurization rate of an oil tank. An embodiment of a method includes obtaining plant information data, classifying an operating period, selecting a modeling data range; determining total gas volume in the tank through data from an oil tank liquid level sensor, determining an average pressure of the gas phase in the tank through the data from the oil tank top pressure sensor, determining an average temperature of the gas phase in the tank through data from an oil tank top temperature sensor, setting the desired oil flow rate, predicting the future pressure in relation to the desired oil flow rate, predicting violation of the critical pressure, determining a period of time of weather calm, and setting a new oil production setpoint.

### FIELD OF THE DISCLOSURE

The present disclosure falls within the technical field of oil production processes and primary processing technologies. In particular, the present disclosure relates to a method for predicting the pressurization rate of oil tanks.

### BACKGROUND OF THE DISCLOSURE

In an oil production system, fluids extracted from reservoirs undergo a series of processes to treat the oil, water and gas produced in order to meet specific requirements for sale, transportation, disposal or reinjection.

In this sense, depending on the processing conditions, the oil may reach the cargo storage tanks with an excessive amount of dissolved gases. These gases tend to separate naturally from the liquid phase, seeking to achieve thermodynamic equilibrium. This release of gases from the liquid phase generates pressure in the storage tanks and, the greater the amount of gases dissolved in the oil, the greater the intensity of the pressure.

In addition, cargo storage tanks are usually massive tanks built along the platform in parallel lines. As a security measure, they are operated with positive gauge pressure to prevent atmospheric air from entering and mixing with the volatile hydrocarbon phase. This procedure reduces the likelihood of a gas explosion and, consequently, mitigates the risk of fire incidents. On the other hand, excessive pressures may exceed the design conditions of the equipment, representing a security risk for the facilities. For this reason, monitoring and controlling cargo tank pressures is very important on offshore oil platforms.

Due to the flammable nature of the product in question, oil storage tanks are closed to the environment, unless ventilation conditions are adequate to disperse the hydrocarbons, preventing the spread of gases throughout the industrial area and reducing the risks of ignition, fire or explosion. However, even in the absence of significant amounts of oxygen in the tanks, moderate concentrations of hydrocarbons in the gas phase may pose a risk of self-ignition. This situation is aggravated when pressurization occurs caused by the release of gases dissolved in the oil.

Although there are emergency measures to control tank pressure, these measures depend on favorable weather conditions, such as wind intensity and direction. In unfavorable weather conditions, emergency measures to control tank pressure can result in risks to the crew, activation of hydrocarbon alarms and possible emergency shutdowns on an oil platform.

### STATE OF THE ART

Currently, there are no methods available on the market or in academia capable of monitoring, predicting and controlling the scenario described above.

In the absence of technologies that allow monitoring, predicting and controlling tank pressurization events, the platform operations team occasionally resorts to emergency depressurization maneuvers when weather conditions are adverse (e.g. low wind speeds). These maneuvers, known as venting, consist of expelling hydrocarbons from the tanks and releasing them into the atmosphere for dispersion. To minimize the risks associated with this procedure, the crew can use an inert gas, generated on the platform itself, as a carrier fluid to expel volatiles, favoring their dilution, or use the pressure accumulated in the cargo tanks as the driving force for the displacement of volatile hydrocarbons.

However, these measures are not sufficient to control critical situations caused by unfavorable weather conditions. In these cases, venting poses a major risk to the security of the platform and is therefore replaced by a general reduction in oil production, through the partial or total closure of producing wells.

Closing producing wells results in significant production losses. Empirically, it is known that this maneuver causes a reduction in the depressurization rate of the tanks, increasing the operating time before the pressure reaches critical levels that make venting inevitable. In other words, reducing well production postpones the need for emergency venting, which is particularly useful in unfavorable weather conditions and serves as a device to wait for a depressurization period with favorable conditions-even if it is at the cost of a reduction in production efficiency.

Despite the qualitative knowledge about the effects of reducing the depressurization rate of the tanks caused by the reduction in well production, there is no quantitative way to measure or predict this dynamic. Therefore, the maneuvers are carried out in a very conservative manner, seeking to postpone the critical pressure scenario as much as possible. As a consequence, production losses are significant, which can have significant impacts on the efficiency and security of industrial facilities in certain operational scenarios.

In the state of the art, the document by Vos, D., Duddy, M., and J. Bronneburg. “The Problem of Inert-Gas Venting on FPSOs and a Straightforward Solution”. Paper presented at the Offshore Technology Conference, Houston, Texas, USA, May 2006. doi: https://doi.org/10.4043/17860-MS, elucidates that wandering inert gas results in a series of emergency shutdowns during cargo tank venting during calm weather conditions, where with no wind to disperse the heavier-than-air gas, the result is the mixture falling onto the main deck of the vessel or into the process modules, triggering the gas detection system of FPSO and subsequently causing an emergency shutdown. To prevent the recurrence of incidents related to IG venting, several operational measures are used, such as: delaying venting during periods of low wind (<2 ms⁻¹) and monitoring the lower explosion limit (LEL) through the gas detection system.

Thus, the problem to be solved is to avoid high pressures in oil tanks. This is necessary because such a situation can lead to emergency venting, where the relief valves open automatically to vent excess gaseous material to the atmosphere. This emergency venting is safe when the wind speed and direction are within a safe range. But it can be dangerous if the wind speed is low or if the direction pushes the vented vapors onto the platform deck. Since hydrocarbon vapor is heavier than air, it will not dissipate easily into the atmosphere, leading to security risks for people who may be on the deck.

To mitigate the risk of fire and poisoning, there are several hydrocarbon sensors spread throughout the deck. Unsafe concentrations trigger alarms to guide the operating crew to avoid the area. In critical concentrations, an emergency shutdown occurs to immediately mitigate the risk of explosion. For this reason, critical pressures in oil tanks are highly undesirable.

Therefore, there is a need for a method that provides greater ease in monitoring pressurization and supports decision-making during platform operation, according to weather conditions, ensuring safer, more efficient and productive operations. Furthermore, there is a clear need to predict the behavior of pressure in oil tanks in different production scenarios, reducing the need for emergency maneuvers that can cause complications in adverse weather conditions.

### BRIEF DESCRIPTION OF THE DISCLOSURE

The proposed disclosure relates to a method capable of monitoring ventilation systems in industrial oil and gas production plants, bringing greater efficiency and security to operations. This method was validated using real operating data from offshore oil platforms, both through offline historical data analysis and real-time validation: in the production environment.

In the validation stage with historical data, data were collected from several sensors of a platform that suffered from production losses due to oil tank pressurization events. These data were sorted, analyzed and processed to create a model capable of accurately predicting tank pressurization dynamics during platform operation, including at different oil production rates.

Offline testing consisted of comparing the model predictions with the results currently measured on the platform under similar conditions.

The model capable of accurately predicting tank pressurization dynamics during platform operation was used by platform operations teams to deal with current pressurization events encountered during production.

With the support of this accurate prediction model, operational decisions related to venting, which were previously made conservatively and based mainly on the subjectivity of operators, began to be optimized in adverse weather conditions. This allowed for better control of venting processes and more efficient operation of industrial plants.

The method for predicting the pressurization rate of oil tanks is implemented through a tool that allows the estimation of the pressurization rates of the oil tanks of all configured platforms and generates predicts for the next hours of operation. This makes it possible to identify when a critical pressure scenario will occur, enabling the appropriate planning of venting maneuvers, taking advantage of favorable weather conditions. This approach reduces the need for emergency maneuvers that can cause complications in adverse weather conditions. Furthermore, even when it is not possible to perform venting maneuvers due to the lack of favorable conditions, the methodology allows the pressurization of tanks to be predicted in different operating scenarios with reduced oil production, thus postponing the occurrence of the critical pressure scenario that requires venting. This tool, together with available weather predicts, makes it possible to operate the platform with maximum productivity without compromising security, even in hostile conditions. The present disclosure relates to a method for predicting the pressurization rate of an oil tank, comprising the steps of:
obtaining plant information data, wherein the plant information data comprises:
   data from at least one oil tank feed oil flow sensor;
   data from at least one oil tank liquid level sensor;
   data from at least one oil tank top pressure sensor; and
   data from at least one oil tank top temperature sensor;
classifying the operating period;
selecting the modeling data range;
determining the total volume of gas in the tank through the data from the oil tank liquid level sensor;
determining the average pressure of the gas phase in the tank through the data from the oil tank top pressure sensor;
determining the average temperature of the gas phase in the tank through the data from the oil tank top temperature sensor;
setting the desired oil flow rate;
predicting future pressure in relation to the desired oil flow rate, using:

$${r}_{p} = \frac{{P}_{K} - {P}_{0}}{{t}_{k} - {t}_{0}}$$

wherein:
P_{K} is the pressure obtained at time t_{K};
P₀ is the pressure obtained at time to, which is prior to t_{K};

$${P}_{i} = \frac{{n}_{i} {RT}_{i}}{{V}_{i}} for i = 0 to K$$

Tᵢ is a temperature value and a linear function of the heating rate, equivalent to the temperature observed in the chosen time interval tₖ−t₀: d_{T}/dₜ=constant;
Vi iₛ a volume value and a linear function of the volume contraction rate, equivalent to the new specified oil flow rate: d_{V}/dₜ=−F_{simulated oil}; and
nᵢ is the amount of matter and a linear function of the vaporization rate, which is a function of the oil flow rate: dₙ/dₜ=f(Fₒᵢₗ);
predicting the violation of the critical pressure;
determining a period of time of climatic calm;
defining a new oil production setpoint.

The plant information data further comprises at least one of:
data from at least one flow sensor or inert gas generation status data;
data from at least one flow sensor or wind status data;
data from at least one flow sensor or oil offloading status data;
data from at least one wind speed sensor;
data from at least one wind direction sensor;
data from at least one oil supply valve opening sensor of the oil storage tank.

Specifically, classifying the operational period involves checking whether the following conditions are all simultaneously met:
there is no injection of inert gas into the oil tanks;
there is no gas venting; and
there is no offloading.

The total volume of gas in the tank is obtained by multiplying the data from the oil tank liquid level sensor by the area of the tank base.

The step of defining the desired oil flow rate is performed by the user.

The critical pressure value is configured by the user.

The critical pressure value is lower than the oil tank relief pressure.

The step of determining the calm weather period involves the user obtaining information about the duration of the calm weather.

The calm weather period includes winds with speeds below 3 knots.

During the calm weather period, oil production is reduced.

Furthermore, according to another preferred embodiment of the present disclosure, a computer-readable storage medium is defined comprising, stored therein, a set of computer-readable instructions, which when executed by a computer, executes the method for predicting the pressurization rate of an oil tank.

### BRIEF DESCRIPTION OF THE FIGURES

In order to complement the present description and obtain a better understanding of the characteristics of the present disclosure, and according to a preferred embodiment thereof, a set of figures is attached, where in an exemplary, although not limitative, manner its preferred embodiment is represented.

FIG. 1 shows the flowchart of the method for predicting the pressurization rate of oil tanks.

FIG. 2 shows the data classification graph.

FIG. 3 illustrates the data selection graph.

FIG. 4 shows the pressure prediction graph.

FIG. 5 shows the pressure simulation graph.

FIG. 6 shows the security simulation graph.

FIG. 7 shows the risk mitigation graph.

FIG. 8 shows a graph of the normalized vaporization rate.

FIG. 9 shows a graph of the pressure data measured during the critical operating intervals.

FIG. 10 shows a graph of the simulation process of the oil flow produced.

FIG. 11 shows a graph of the expected impact on the tank pressure.

FIG. 12 illustrates the selection of the time window.

FIG. 13 shows the selection of the new time window.

FIG. 14 represents the pressure correlation matrix.

FIG. 15 represents the temperature correlation matrix.

FIG. 16 represents the level correlation matrix.

FIG. 17 shows graphs of relevant variables.

FIG. 18 highlights the results of the gas phase modeling for each component.

FIG. 19 shows a comparison of the typical compositions expected in the plant.

FIG. 20 (a) highlights the classification result.

FIG. 20 (b) displays the classification histogram.

FIG. 21 illustrates the selection of an analysis period.

FIG. 22 shows the procedure for choosing the sensors.

FIG. 23 shows the procedure for choosing the sensors.

FIG. 24 indicates the procedure for choosing the sensors.

FIG. 25 shows a diagram of normalized contributions of each effect considered in the model.

FIG. 26 illustrates how most of the selected cases in critical operation behave.

### DETAILED DESCRIPTION OF THE DISCLOSURE

The method for predicting the pressurization rate of oil tanks, according to a preferred embodiment of the present disclosure, is described in detail below, based on the attached figures.

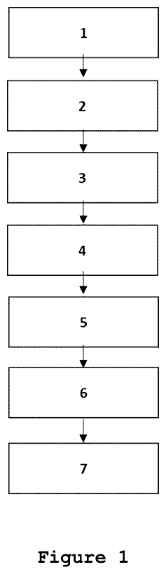

FIG. 1 illustrates a flowchart of the method for predicting the pressurization rate of oil tanks, according to a preferred embodiment of the present disclosure.

### Step 1: Obtaining Plant Information Data

The method for predicting the pressurization rate of oil tanks comprises obtaining plant information data, wherein the plant data comprises data from sensors related to the oil tanks.

Preferably, the plant information data that are fundamental and continuously collected are:
Data from the oil flow sensors that feed the oil storage tanks (typically the flow sensors of the fiscal measurement station);
Data from the liquid level sensors of each of the oil storage tanks;
Data from the top pressure sensors of each of the oil storage tanks; and
Data from the top temperature sensors of each of the oil storage tanks.

Furthermore, preferably, the plant information data that are optional, which bring benefits to the predictive capacity, usability and assertiveness of the method of the present disclosure, continuously collected are:
Data from the flow sensors or data on the state of the inert gas generation (on platforms where such current is used as a drag fluid in the venting maneuver);
Data from flow sensors or data on the state of the vent (such as the pressure differential at the vent post flame arrester);
Data from flow sensors or data on the state of the oil offloading (unloading);
Data from wind speed sensors;
Data from wind direction sensors;
Data from the oil supply valve opening sensors of each of the oil storage tanks.

Specifically, in the application and construction of the model that performs the method for predicting the pressurization rate of oil tanks of the present disclosure, an extensive database containing 807 measured tags from 2 years of operation, generating approximately 6 GB of data, was made available for analysis. In addition, process flow diagrams, tank dimension diagrams, process and instrumentation diagrams, operating rules and other supporting materials were also made available. Before processing and visualizing such a large volume of data, a rigorous variable selection procedure was applied to guide the analysis. Based on the conceptualization of the problem and the expected solution, a first subset of tags was highlighted from the original database. These variables were directly involved in the main phenomena in the system, i.e., hydrocarbon vaporization. Therefore, the most obvious tags were related to tank pressures, temperatures, levels, oil feed flow, oil outlet flow, inert gas feed (used to control pressure during the oil discharge procedure) and ventilation flow (used to relieve pressure when it reaches critical levels). All raw data were checked to remove unexpected texts and treat missing data. In this procedure, irregular input is replaced by the last available measurement.

### Step 2: Classifying the Operational Period

Before performing a simulation from the method for predicting the pressurization rate of an oil tank, it is necessary to verify whether the operational period is eligible for application of the model.

Thus, the model that implements the method for predicting the pressurization rate of an oil tank can only be applied in an operational period in which the following conditions are simultaneously true:
there is no injection of inert gas into the oil tanks;
there is no venting of gases; and
there is no offloading (discharge of oil from the tanks).

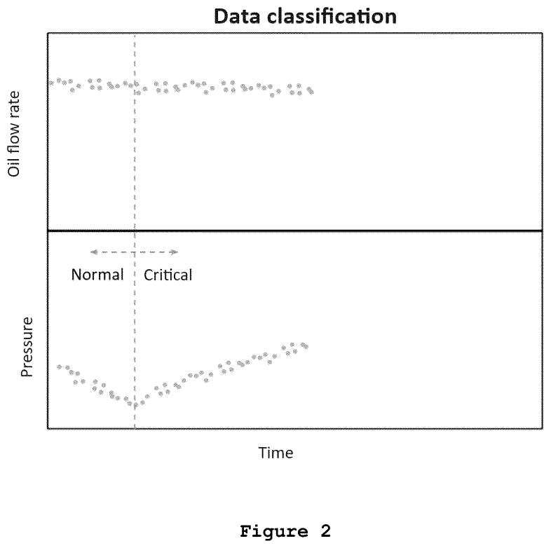

As shown in FIG. 2, during this operational period, where all the above conditions are met, the operation is classified as critical, as there is a tendency for the oil tanks to pressurize. Outside these conditions, the model is not valid.

### Step 3: Selecting the Modeling Data Range

The user, through the human-machine interface, is responsible for selecting the simulation modeling range.

This modeling range should be a period of stable operation and be as current as possible, to increase the chances of an accurate simulation. It is based on this range of modeling data that the model will be built and extrapolated to new oil production conditions.

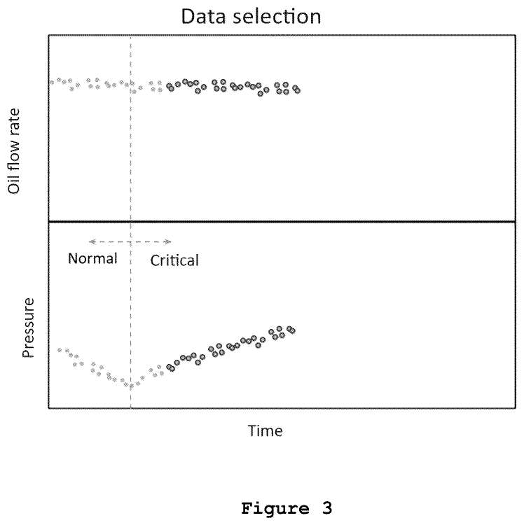

According to FIG. 3, the darker points mark the selection of said range.

After selecting the modeling range, the user, through the human-machine interface, is responsible for selecting the pressure, temperature and level sensors that is intended to be used in the modeling, since equipment defects are common.

### Determining the Total Volume of Gas in the Tanks, Average Pressures and Temperatures of the Gas Phase

The plant information data is sent for processing, wherein the method for predicting the pressurization rate of an oil tank also includes determining the total volume of gas in the tanks, average pressures and temperatures of the gas phase.

In general, the total volume of gas in the oil tanks is calculated by determining the total volume of the tanks minus the volume of oil measured. The procedure can be described in detail as follows:
Acquiring, with a sampling period of 1 minute, and gathering data from the level sensors of each of the oil tanks based on the “Modeling Interval” selected by the user through the human-machine interface, as well as the total volumes resulting from the sizing of each of the tanks;
The user, through the human-machine interface, is responsible for selecting the sensors that is intended to be used in the modeling, since it is common for defects to occur in the equipment;
Using a moving average filter tuned with a 5-minute window on the data from the selected level sensors;
Imputing any missing data using the criteria of repeating the last valid value forward (forward fill) and then backward (backward fill);
Calculating the area of the base of each of the oil tanks by dividing their respective individual total volumes (from the sizing) by their corresponding height (Abi=Vti/Ai);
Tank level sensors display values in units of meters, so simply multiply each measured level (which represents the gas column) by its respective base area corresponding to the tank in question, resulting in the gas volume of the tank (Vgi=Lgi*Abi). The sum of the volumes obtained represents the total volume of gas estimated in the tanks;
As an extra step, it is possible to estimate the total volume of stored oil (oil inventory). To do this, simply calculate the arithmetic sum of the total volumes resulting from the sizing of the tanks corresponding to the sensors selected by the user and subtract the total volume of gas estimated in the tanks from this value. The same result can be obtained by multiplying the calculated base area of each of the oil tanks and level data of the inagem type, when available.

The calculation of average pressures includes:
Acquiring, with a sampling period of 1 minute, and gathering the data from the top pressure sensors of each of the oil tanks based on the “Modeling Interval” selected by the user through the human-machine interface;
The user, through the human-machine interface, is responsible for selecting the sensors intended to be used in the modeling, since it is common for defects to occur in the equipment;
The selected sensors are subjected to the calculation of the arithmetic mean, resulting in the aforementioned average pressure of the tanks.

The calculation of average temperatures includes:
Acquiring, with a sampling period of 1 minute, and gathering the data from the top temperature sensors of each of the oil tanks based on the “Modeling Interval” selected by the user through the human-machine interface;
The user, through the human-machine interface, is responsible for selecting the sensors intended to be used in the modeling, since it is common for defects to occur in the equipment;
The selected sensors are subjected to the calculation of the arithmetic mean, resulting in the referred average temperature of the tanks.

### Construction and Validation of Models for the Method for Predicting Pressurization Rate of an Oil Tank of the Present Disclosure

### Modeling of the Gaseous Phase

In the present case, the global mass balance for the gaseous system can be expressed by the following equation 1:

$$\frac{dM}{dt} = {F}_{in} + {F}_{vap} - {F}_{out} \qquad equation 1$$

where M is the total accumulation of gaseous mass in the tanks,
t is the time,
Fᵢₙ is the inert gas flow rate,
Fᵥₐₚ is the hydrocarbon vaporization flow rate, and
Fₒᵤₜ is the vented gas flow rate.

Usually, none of the global mass balance flows have direct measurements. Therefore, it is not possible to close the mass balance. However, the gas retention term can be calculated in another way. The gas phase has direct measurements of its pressure and temperature. Using data from tank levels, it is possible to model the volume of the gas phase. Therefore, considering T, P and V known, it is possible to model the amount of matter using an equation of state of the gas. Two approaches were tested in order to define which equation best fits the problem: equation 2 of the ideal gas law or Van der Waals equation 3 of state, parameters a and b of which can be easily found in thermodynamic tables.

### Ideal Gas Law Equation 2:

$$( P + \frac{{an}^{2}}{{V}^{2}} ) ( V - nb ) = nRT \qquad equation 3$$

### Van Der Waals Equation 3:

$$PV = nRT \qquad equation 2$$

Two comparisons were made between the models, one between pure components and the other between mixtures of components. The first comparison aims to evaluate the behavior of the model for each gas component in the temperature and pressure range observed in the operating conditions. The pressure varies from 1 bar to 1.1 bar absolute and the temperature typically varies from 30° C. to 45° C. The main components in the system are water vapor, nitrogen, carbon dioxide, methane, ethane, propane, butane, pentane and hexane. The absence of oxygen is essential to avoid the risk of explosion. In order to verify the overall behavior of the equations in a production environment, a second comparison was made using mixtures in expected mixtures. Under the same P, V and T conditions as in the first comparison, two mixtures were evaluated: pure hydrocarbon and hydrocarbon diluted in inert gas, the mass fractions of which are shown in Table 1 below.

TABLE 1
Mass fractions of pure hydrocarbon and hydrocarbon
diluted in inert gas

| Component | Pure gas | Diluted gas |
|---|---|---|
| Water | 0.0 | 11.0 |
| Nitrogen | 0.0 | 36.0 |
| Carbon dioxide | 9.0 | 5.3 |
| Methane | 1.0 | 1.3 |
| Ethane | 7.0 | 5.0 |
| Propane | 26.0 | 15.0 |
| Butane | 29.0 | 15.0 |
| Pentane | 16.0 | 6.6 |
| Hexane | 12.0 | 4.8 |

Pure hydrocarbon is the expected composition of treated gas from the reservoir. However, during offloading and security venting operations, the reservoirs are fed with inert gas to control pressure and push gases, respectively. Thus, the current composition of the gas phase is expected to be closer to the diluted fractions than to pure gas.

### Classifier Modeling

To model the gas phase, a strong constraint must be respected. The gas phase must be free of inlet and outlet flows. In other words, there must be no active inlet flow of inert gas or active outlet flow of ventilation. During this particular moment, the gas phase is completely confined in the tanks and tends to accumulate, as a consequence of the vaporization of volatiles from the oil. In addition, the accumulation of oil produced reduces the available gas volume, causing the pressure to increase. This entire situation is considered critical, because there are no longer any degrees of freedom for the operation to control the pressurization of the tanks. In this scenario, the pressure may reach explosive critical levels, triggering an emergency relief. Considering the unavailability of winds to disperse the gases, emergency relief may lead to the hazardous events discussed above, such as crew contamination and emergency shutdown. For this reason, the method for predicting the pressurization rate of oil tanks was designed to support decisions during these critical operating scenarios.

A classifier was built to identify and isolate the periods of interest discussed above. Tags from the inert gas generation train were used to define whether there was gas injection into the tanks. Tags from the differential pressure in the flame arrester were used to define whether there was a venting procedure. As a redundancy measure, the first derivative of the total volume of oil in the tanks was used to define whether there was a discharge procedure. In summary, the operation is considered critical when all the conditions below are true:

$$\begin{matrix}GI = 0 \\ Δ {P}_{cc} < 1 mbar \\ \frac{Δ {V}_{oil}}{dt} > {1.1}^{- 4} {m}^{3} / h\end{matrix}$$

As can be seen, it is necessary to calculate the total oil volume ΔVₒᵢₗ to verify its derivative. However, this information is not measured directly from the process. Therefore, a model was built that describes the accumulation of the liquid phase. By combining information about the dimensions of the tanks and the individual levels, the total oil can be easily estimated. Due to measurement noise, a moving average was used to smooth the data and give greater reliability to the estimates. Because of this, a minimum window of 30 minutes of operation is required to provide an adequate profile for the calculation of the numerical derivative.

As mentioned above, this classifier was built to identify and isolate periods of interest. To this end, all available data were submitted to the classifier, assigning the value 0 to the periods of interest and the value 1 to the remaining ones. The periods obtained were listed by duration, where all events lasting more than two hours were selected for further evaluation and model validation. Other periods were discarded.

In summary, a critical operation is characterized by a reduction in the volume available for the confined gas phase. This situation will inevitably cause pressurization in the tanks. The only degree of freedom left to control such a situation is the flow rate of oil produced. Therefore, an algorithm to simulate new oil production conditions becomes essential to control these critical events on the platform.

### Simulator Modeling

The simulator was built to provide the ability to test new operational scenarios and predict their impacts on the pressurization of the oil tanks. A simple linear model y=a+b was used to represent the expected future pressure in the tanks, according to equation 4.

$${P}_{simulated} = {r}_{P} t + {P}_{current} \qquad equation 4$$

where:
P_{simulated} is the result of the pressure simulation in the new condition,
r_{P} is the estimated pressurization rate for the new condition,
t is the simulated future time, and
P_{current} is the pressure measured at the time of the simulation.

Although the final representation of the simulated pressure is quite simple, the pressurization rate model as a function of oil production is not. This rate model was built empirically, entirely based on operational data. The procedure was carried out in this way because the ideal gas equation does not allow the direct use of the rates of each variable. Furthermore, its algebraic derivation as a function of time returns a complicated and unintuitive equation.

Therefore, the pressure was calculated using linear extrapolations of each of the variables involved in the ideal gas equation, as described in equation 5 below:

$${r}_{p} = \frac{{P}_{K} - {P}_{0}}{{t}_{k} - {t}_{0}} \qquad equation 5$$

$${P}_{i} = \frac{{n}_{i} {RT}_{i}}{{V}_{i}} for i = 0 to K$$

where:
P_{K} and P₀ are the pressures obtained for the new conditions at times t_{K} and t₀, respectively.

The instants t₀ and t_{K} delimit the time interval chosen to estimate r_{P}. This choice is made by the user and must respect the viability conditions of the model described by the classifier to generate a reliable simulation. The careful selection of this time interval is important, because it influences the capture of temperature and vaporization profiles, which will be used to run the simulation. Equation 5, above, estimates the expected pressure given the simulation conditions, according to the following hypotheses:
The temperature Tᵢ is a linear function of the heating rate, which in its turn is equivalent to that observed in the chosen time interval: d_{T}/dₜ=constant;
The volume Vᵢ is a linear function of the volume contraction rate, which in its turn is equivalent to the new specified oil flow rate: d_{V}/dₜ=−F_{simulated oil};
The amount of matter nᵢ is a linear function of the vaporization rate, which in its turn is a function of the oil flow rate: dₙ/dₜ=f(Fₒᵢₗ).

All linear functions described above are of the type y=a+b, where a is the term of the respective derivative d_{y}/dₜ, and b is the last available measurement of the respective variable y₀. As can be seen, the temperature and volume derivatives are easily solved, because the first is kept constant and the second is automatically defined by the user when choosing the new oil flow value. The simulator modeling can be seen in FIGS. 2, 3, 4, 5, 6 and 7.

### Vaporization Modeling

Vaporization is a complex thermodynamic phenomenon to model, since it uses physical properties of the gas that depend on its temperature and composition. Since there are no measurements available for the composition of the gas phase and considering its frequent mixing with inert gases, it is difficult to estimate the thermodynamic properties of the fluids.

The liquid phase of the oil also undergoes changes in temperature and composition, mainly due to the primary treatment conditions and the composition of the substance in the reservoir.

Therefore, the best approach in this situation is to find a direct relationship between the vaporization rate and the operating conditions. In this case, the most important operating condition is the oil flow rate produced.

To carry out this approach, the periods of interest resulting from the classification were analyzed according to the behavior of the production flow rate during each interval. The ideal condition is found when there are at least two stable and different levels of oil production. In other words, the ideal behavior for building the vaporization model is when there is a change in the production operation, whether it increases or decreases.

Each period is modeled individually to estimate its corresponding vaporization rate. Under the conditions imposed by the classification, the vaporization rate is equivalent to the accumulation rate of the amount of matter, since there are no entries or exits of gaseous material. Therefore, this estimate can be calculated in a similar way to the estimate of the pressurization rate. Equations 6 and 7 below illustrate the procedure.

$$\frac{dn}{dt} = \frac{{n}_{M} - {n}_{0}}{{t}_{M} - {t}_{0}} \qquad equation 6$$

$${n}_{i} = \frac{{P}_{j} {V}_{J}}{{RT}_{j}} for j = 0 to M \qquad equation 7$$

Although similar, the approach has major differences in relation to the estimation of the pressurization rate. The main one refers to the time interval. The pressurization rate is estimated over a period chosen by the user when using the framework. The vaporization rate is an offline estimate, using historical data to compose a static model that serves as a reference for the simulation of pressure as a function of oil flow.

Each estimated vaporization rate is associated with a stationary period of oil flow. This allows the construction of a dₙ/dₜ versus Oil map, correlating both variables. Since most of the periods obtained in the classification have only two levels of oil flow, straight lines were drawn joining the estimated points of the vaporization rate to highlight each operating interval. This aims to evaluate points subject to similar conditions in terms of thermodynamic properties.

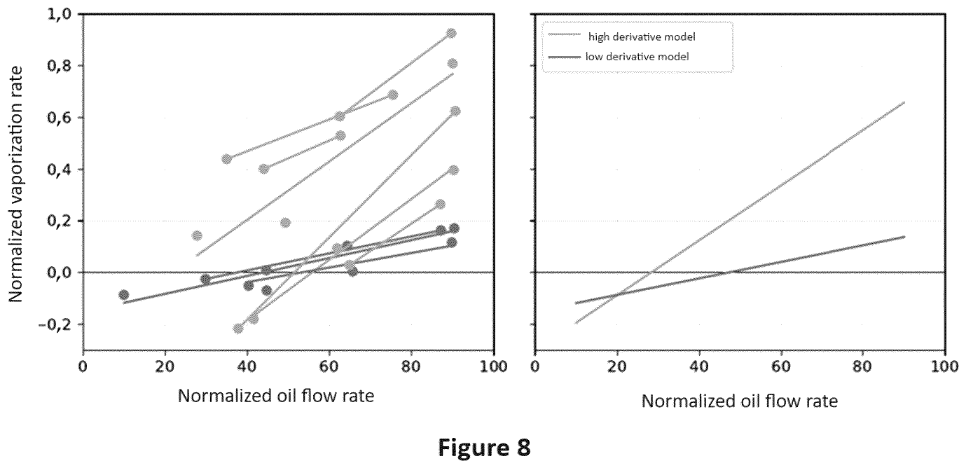

Since the change in oil flow rate occurs within a window on the scale of a few hours, no major changes in composition, temperature or efficiency of the treatment system are expected. Therefore, the relationship between the vaporization rate and the oil flow rate is reliable. In the situation where the estimated points are distant in time, this comparison is not reliable, since the thermodynamic properties of the medium may change. By comparing these operating intervals, it is possible to draw a global model, which will serve as a reference for simulating the vaporization rate given an oil flow rate. The result of this analysis is summarized in FIG. 8.

According to the graphs in FIG. 8, it is possible to note the existence of a trend of higher vaporization rates for higher flow rates and lower vaporization rates for lower flow rates.

However, there is a large dispersion of values, especially in the region of higher flow rates. By observing local trends, i.e. data obtained within the same analysis interval, it is possible to note two global behaviors that govern the relationship between the vaporization rate and the oil flow rate. The first behavior is characterized by a high derivative in the region of high vaporization rate and high oil flow rate. In this region, a strong reduction in the vaporization rate is observed due to the reduction in flow rate. The second behavior occurs in regions of low vaporization rate and covers the entire flow range, from high to low. In this situation, it is very difficult to propose a single model capable of representing all the observed operational points. Therefore, the simplest way is to divide the model into two parts. Graphically, it is possible to draw a horizontal line, dividing the operation into two vaporization rate regions. The high rate regions will be represented by the high derivative model. The low rate regions will be represented by the low derivative model. Equations 8 and 9 below represent the vaporization models for each operational region.

$${r}_{vapH} = {a}_{H} {F}_{oil} + {b}_{H} \qquad equation 8$$

$${r}_{vapL} = {a}_{L} {F}_{oil} + {b}_{L} \qquad equation 9$$

The vaporization model that will be used in the pressure prediction is selected based on the estimated vaporization rate in the modeling period selected by the user. Rates greater than 0.2, in normalized values, automatically select the model described as r_{vapH}, while lower values indicate the r_{vapL} model.

### Step 4: Pressure Prediction

In critical conditions, it is essential to understand how the pressure behaves so that it is possible to predict when it will violate the tank security limits.

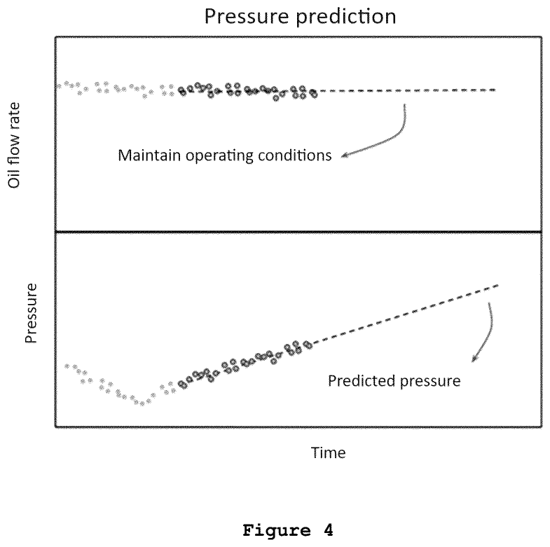

FIG. 4 illustrates the pressure prediction graph.

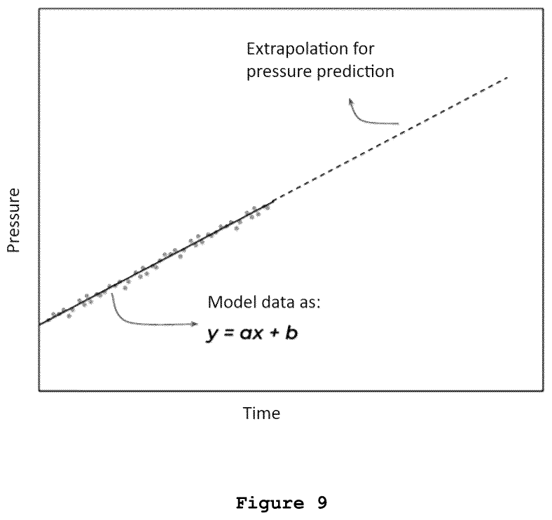

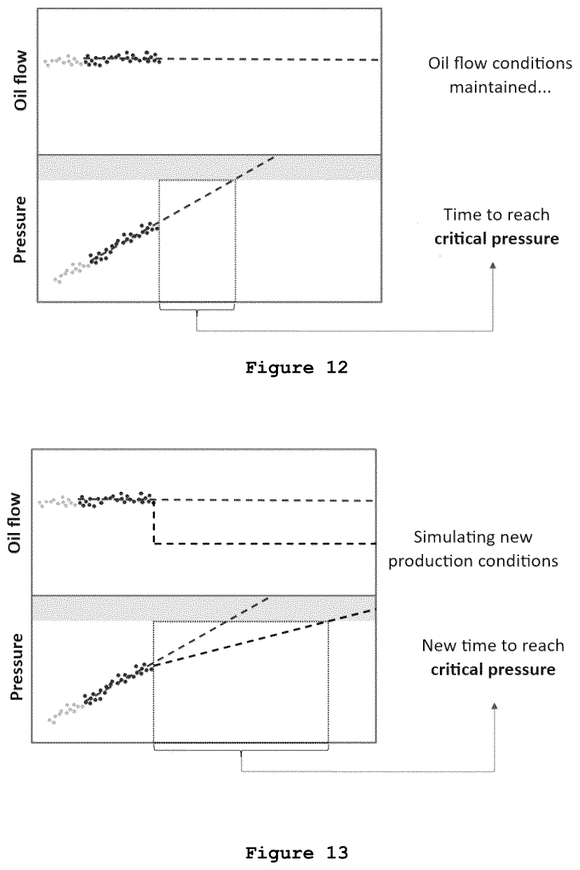

In addition, according to FIGS. 9 and 12, analyzing the pressure data measured during the critical operating intervals, it is possible to note a linear and predictable pressure behavior. Therefore, from a user-defined data set, i.e. the modeling data range selected in step 3, it is possible to fit a straight line that passes through the points and extrapolate it to predict future pressure behavior, keeping the other operating conditions constant. The predictor can be interpreted as an autoregressive model, and is described mathematically in equation 10 below:

$${P}_{future} = {d}_{P} / {d}_{t} t + {P}_{current} \qquad equation 10$$

where:
P_{future} is the predicted pressure;
d_{P}/dₜ is the pressurization rate identified in the selected time period;
t is the future time; and
P_{current} is the most recent measured pressure.

With the pressure prediction, the user can decide whether the scenario is risky or not, comparing the future pressure with the admissible critical pressure.

### Step 5: Precisely Predict Future Pressure in Relation to Oil Flow

Based on the behavior of the average pressure over time, it is possible to accurately predict future pressure in relation to oil flow, as long as the operating conditions for oil production are maintained.

The user defines the desired oil flow and the method calculates the future pressurization rate, adjusting it based on the current pressurization condition.

The method for predicting the pressurization rate of oil tanks of the present disclosure brings together two basic classes of future pressure prediction in relation to oil flow:
Autoregressive method: used to predict future pressure while maintaining the oil production flow unchanged;
Hybrid method: used to predict future pressure in different oil production flow scenarios.

### Autoregressive Method

As shown in FIG. 9, from a user-defined data range (“Modeling data range”), it is possible to adjust a linear behavior that passes through the points and extrapolate it to predict the future behavior of the pressure, keeping the other operating conditions constant. The predictor can be interpreted as an autoregressive model, and is described mathematically as follows, in equation 10.

$${P}_{future} = {d}_{P} / {d}_{t} t + {P}_{current} \qquad equation 10$$

where:
P_{future} is the predicted pressure,
d_{P}/dₜ is the pressurization rate identified in the selected time period,
t is the future time, and
P_{current} is the most recent measured pressure.

### Hybrid Method

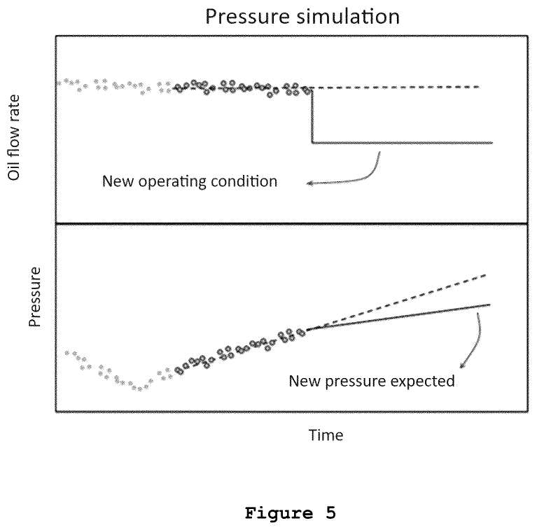

If the user concludes that the pressurization scenario is unsafe due to the weather conditions predicted for the future time horizon, a new production scenario can be simulated for the platform and its effect evaluated on pressurization, as shown in FIGS. 5 and 13.

The pressure predict in different oil flow scenarios depends intrinsically on the associated predict of the rates of variation of volume, temperature and amount of matter. This is because this disclosure proposes the use of a hybrid model whose basic equation is the same as that associated with the autoregressive model, as shown in equation 10, where P is the pressure and t is the time.

$${P}_{future} = {d}_{P} / {d}_{t} t + {P}_{current} \qquad equation 10$$

The term referring to the derivative of the pressure is the so-called pressurization rate, which, in its turn, is a function of the volume, temperature and amount of matter, as shown in equation 11 below.

$$\frac{dP}{dt} = f ( \frac{dV}{dt} , \frac{dn}{dt} , \frac{dT}{dt} ) \qquad equation 11$$

To simplify the notation, the pressurization rate is represented as rₚ. In mathematical terms, the calculation of rₚ is represented according to equation 5, previously indicated:

$${r}_{p} = \frac{{P}_{K} - {P}_{0}}{{t}_{k} - {t}_{0}} \qquad equation 5$$

$${P}_{i} = \frac{{n}_{i} {RT}_{i}}{{V}_{i}} for i = 0 to K$$

where:
P_{K} and P₀ are the pressures obtained for the new conditions at times t_{K} and t₀, respectively.

The instants t₀ and t_{K} limit the time interval chosen to estimate r_{P}. This choice is made by the user and must respect the model feasibility conditions described by the classifier to generate a reliable simulation. Careful selection of this time interval is important because it influences the capture of temperature and vaporization profiles, which will be used to run the simulation. Equation 5, above, estimates the expected pressure given the simulation conditions, according to the following assumptions:
The temperature Tᵢ is a linear function of the heating rate, which in its turn is equivalent to that observed in the chosen time interval: d_{T}/dₜ=constant;
The volume Vᵢ is a linear function of the volume contraction rate, which in its turn is equivalent to the new specified oil flow rate: d_{V}/dₜ=−F_{simulated oil};
The amount of matter nᵢ is a linear function of the vaporization rate, which in turn is a function of the oil flow rate: dₙ/dₜ=f(Fₒᵢₗ).

All linear functions described above are of the type y=a+b, where a is the respective derivative term d_{y}/dₜ, and b is the last available measurement of the respective variable y₀. The temperature and volume derivatives are easily solved, because the first is kept constant and the second is automatically defined by the user when choosing the new oil flow rate value.

The vaporization rate is a function of the oil production rate. Thus, a mapping of the average vaporization rate in calm periods versus average oil production rates was developed. Vaporization rates were calculated from equations 6 and 7, previously highlighted:

$$\frac{dn}{dt} = \frac{{n}_{M} - {n}_{0}}{{t}_{M} - {t}_{0}} \qquad equation 6$$

$${n}_{i} = \frac{{P}_{j} {V}_{J}}{{RT}_{j}} for j = 0 to M \qquad equation 7$$

The pressurization rate is estimated over a period chosen by the user when using the framework. The vaporization rate is estimated offline, using historical data to compose a static model that serves as a reference for simulating pressure as a function of oil flow.

Each estimated vaporization rate is associated with a stationary period of oil flow. This allows the construction of a dₙ/dₜ versus Oil map, correlating both variables.

The selection of the vaporization model that will be used in the pressure prediction is based on the vaporization rate estimated in the modeling period selected by the user. Rates greater than 0.2, in normalized values, automatically select the model described as r_{vapH}, while lower values point to the r_{vapL} model.

### Step 6: Prediction of the Critical Pressure Violation

With the corrected pressurization rate, the current average pressure in the tanks is extrapolated into the future, allowing the prediction of the moment when the critical pressure will be violated and will require an emergency venting maneuver.

Conceptually, critical pressure is the maximum pressure allowed by the oil tank for safe operation, mitigating the risk of self-ignition of volatile hydrocarbons present in the gas phase. All tanks have relief systems in case the pressure exceeds previously defined values. However, if relief occurs during calm weather, the vented gases may return to the deck, due to their density, and increase incidents such as crew poisoning, serve as fuel for fires or cause an ESD on the platform. Therefore, critical pressure serves as an operational security reference and should not be violated.

Typically, tank relief pressure is around 100 to 120 mbar manometric. However, the value used as critical pressure in this disclosure can be any value defined by the tool user.

Defining the critical pressure value is the responsibility of the tool user, through the human-machine interface, and may follow specific criteria. However, it is advisable that the critical pressure value be lower than the tank relief pressure, to provide a security margin due to numerical errors in the approximations.

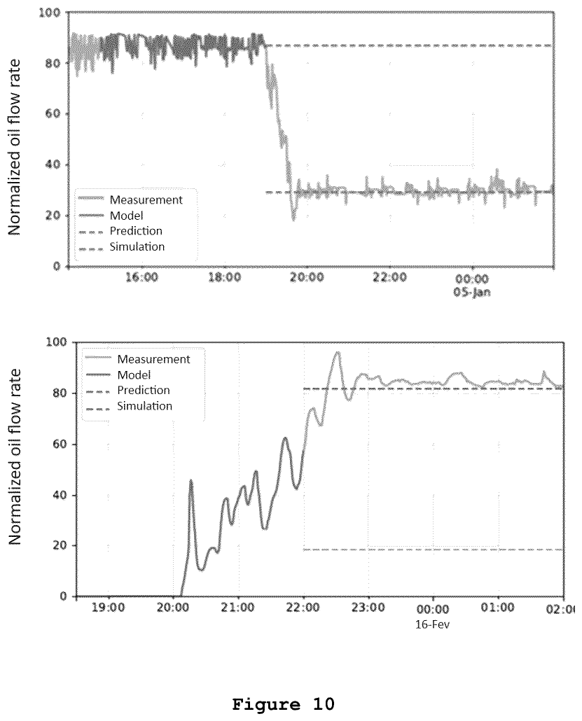

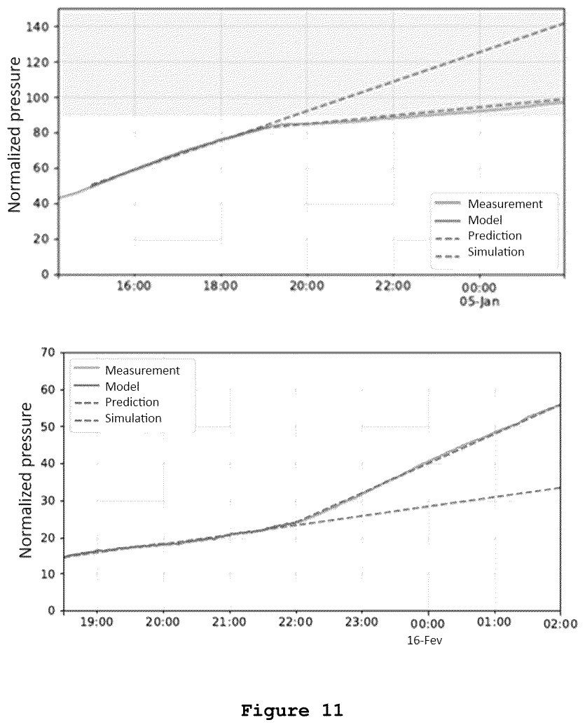

After selecting the simulation tuning parameters, the results are displayed graphically, where it is possible to verify the intersection between the predicted/simulated pressure and the critical pressure adjusted by the user, as shown in FIGS. 10 and 11, determining the moment at which the critical pressure will be violated.

Specifically, the graph in FIG. 10 represents the simulation process of the oil flow produced, while the graph in FIG. 11 shows the expected impact on the tank pressure.

It is noted that the critical pressure (FIG. 11) was numerically defined as 90 (area filled with color). If the operating conditions remain unchanged, the critical pressure is expected to be violated shortly before 8:00 p.m. In conditions of reduced production flow, a critical pressure violation is expected after 8:00 p.m., as can be seen in the intersections between the lines on the graph. The same procedure, with the same graphs, is available in the human-machine interface of the tool that performs the method of the present disclosure.

The numerical value that interests the user in relation to the moment that the critical pressure is violated is the instant of time in which the violation occurs. In this way, an operating period compatible with the expected climatic conditions can be projected.

In this way, the new simulated operating condition must be compared with the current condition in order to trace the expected time difference to reach the critical pressure (security limit).

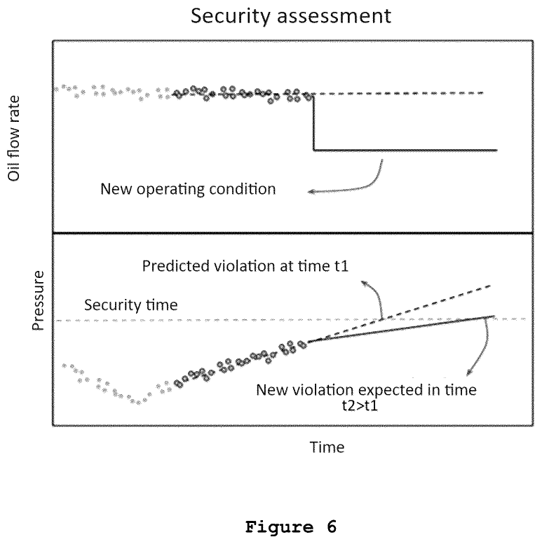

In FIG. 6, the new production condition causes a delay in the violation of the critical pressure due to the reduction in the pressurization rate.

In practice, the user of the tool that develops the method of the present disclosure decides the new production condition aiming at the lowest possible loss that guarantees safe operation within the predicted period of climate abnormality (absence of winds) made available by a third-party application.

### Determining the Period of Time of Climate Calm

The user consults the climate predict data to obtain information on the duration of the climate calm.

A calm occurs when the wind speed reaching the platform is not sufficient to disperse the hydrocarbon cloud vented from the oil tanks. This value may be different for each platform and is affected by the wind direction. Computational fluid dynamics studies carried out with some platforms reveal that speeds below 6 knots may be insufficient to disperse the gases when the wind direction points towards the deck, while speeds below 3 knots may cause gas flooding on the deck for any wind direction.

Based on this time window, the user determines the required duration of the operating window with reduced oil production.

### Step 7: Defining New Oil Production Setpoint

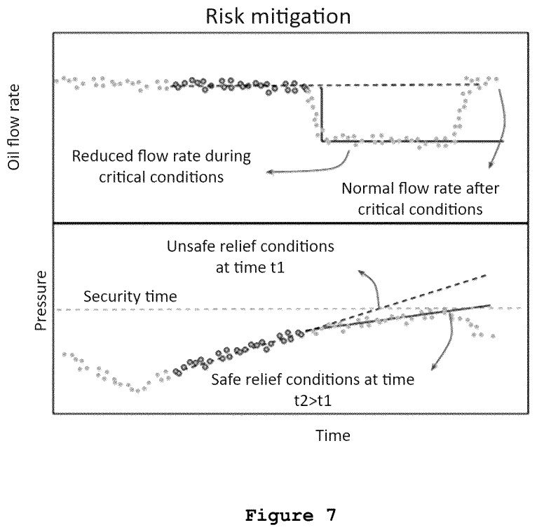

Once the new optimized production flow rate has been identified, the production team takes the platform to the new production setpoint, which is maintained until weather conditions allow for venting maneuvers, as shown in FIG. 7.

The objective of the user with the method of the present disclosure is to ensure maximum oil production during a time interval in which venting maneuvers can generate serious consequences for the operation. In this sense, the classic scenario occurs when there is a need to delay the moment at which the relief pressure is reached, because if it is violated, there will be automatic venting that can result in damage to the platform and crew. This procedure is illustrated in FIGS. 2, 3, 4, 5, 6 and 7.

Using the interface of the tool that performs the method of the present disclosure, the user adjusts the production flow rate until the predicted time window is sufficient to accommodate the corresponding and tolerable pressurization, taking into account the weather scenario. FIG. 12 shows the time to reach the critical pressure and FIG. 13 illustrates the choice of a new time window to reach the critical pressure.

### Results

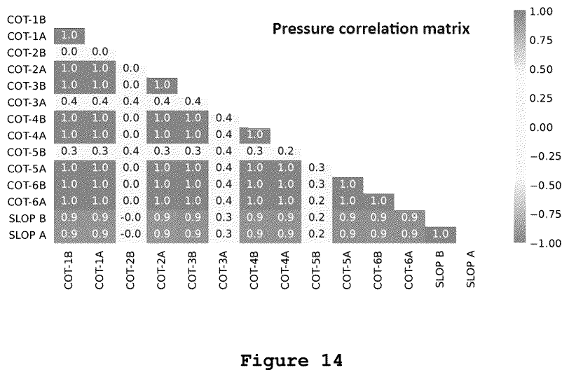

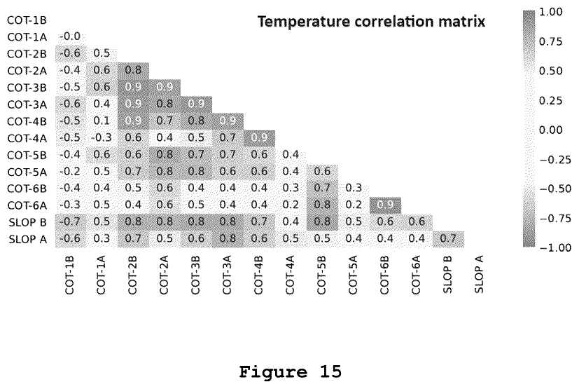

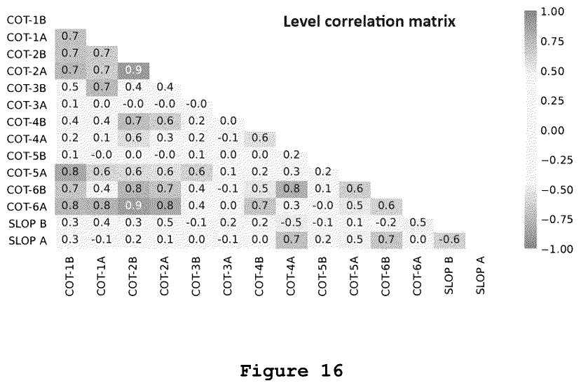

The oil tanks have isolated liquid phases and interconnected gaseous phases. In other words, the liquid phase does not flow from one tank to another, while the gases flow unrestricted between them. Consequently, the entire gaseous phase is connected and can be clearly seen through the correlation of the pressure tags in the tanks, confirming that the behavior of all pressures is very similar throughout the tanks. This phenomenon is not observed in the temperature because, in this case, the heat transport is much slower than the mechanical effect of the mass flow. This is evidenced by the correlation matrix of FIGS. 14, 15 and 16. The pressures, in general, have correlations above 0.98, while the temperatures range between 0.50 and 0.90, indicating a medium-high correlation. The level data showed medium-low correlation, indicating that the tanks are operated independently from each other for loading and unloading.

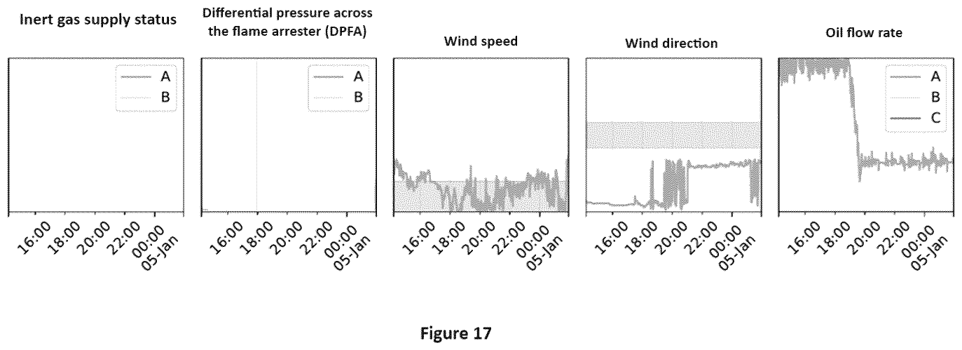

According to FIG. 17, other relevant variables are the oil flow rate for loading and unloading, differential pressure across the flame arrester (DPFA), inert gas generation, and wind speed and wind direction. The oil feed flow rate is a sum of three parallel lines instrumented at the oil fiscal measurement station. The flow that passes through the measurement station goes entirely to the cargo tanks. During loading, two or three tanks are normally chosen by the operation to receive the oil based on the available volume. This procedure is simply called production. A similar logic is applied to the oil discharge procedure, called offloading. Measurements are available for both procedures.

The DPFA is the difference between the pressures upstream and downstream of the flame arrester. Therefore, it is a measure of the intensity of the venting procedure. The higher the differential pressure, the greater the flow of gases to be vented. When DFPA is zero, there is no gas outflow from the tank, but there is no direct measurement available for the vent flow.

The tag related to the inert gas generation is categorical and indicates whether the generation train is on or off. In order to give more versatility to this data, the tag was mapped by replacing the on and off values with the integers 1 and 0, respectively. The inert gas generation trains are turned on in two situations: to control the pressurization of the tank during a discharge and to push excess hydrocarbon gases during a security venting procedure.

The speed and direction of the wind are very important to guide the venting procedure. Depending on the wind conditions, the procedure cannot be performed safely because the gases may return to the platform deck. Since the hydrocarbon mixture is denser than air, a low-speed wind or one flowing in the same direction as the platform will cause the gas to reach the deck. To mitigate the risk of fire and crew poisoning, there are several sensors located throughout the deck to detect hydrocarbons. When the concentration reaches unsafe levels, an alarm is triggered to alert the crew to the problem. In the worst-case scenario, critical concentrations will trigger an emergency shutdown, which is highly undesirable.

### Model Performance

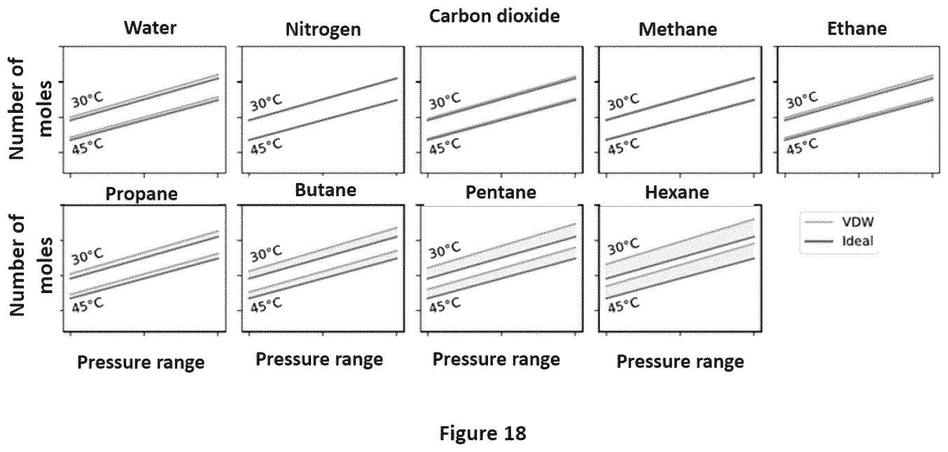

The results of the gas phase modeling for each component are summarized in FIG. 18. The comparison involves calculating the amount of matter, N, using both the ideal gas and the Van der Waals equations for fixed V and a defined range of T (30 to 45° C.) and P (1 to 1.1 bar abs). As can be seen, the models are equivalent across the entire operating range for the lighter components, such as water vapour, nitrogen, carbon dioxide, methane and ethane. Significant differences arise for the heavier components, such as propane, butane, pentane and hexane. In other words, both models adapt well to a gas phase rich in light components. The heavier the composition, the more divergent their behaviors. Therefore, the choice of the best model depends on the composition of the gas found in the tanks.

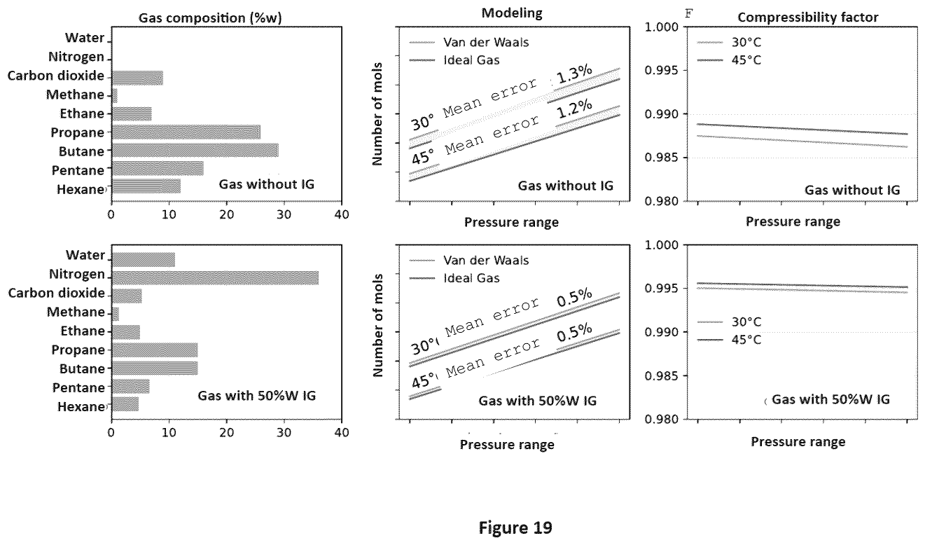

FIG. 19 shows a complete comparison considering the typical compositions expected in the plant. The top row shows results for a gas phase composed purely of hydrocarbons, including its composition (left), amount of matter (center), and compressibility factor (right). However, the operation often uses inert gas during the unloading and venting procedures, as discussed in the previous section. Thus, the typical gas phase of the tank is diluted. A mass fraction of inert gas of 50% was considered as the expected composition in the bottom row of the same FIG. 19. As can be seen, the difference between the models reduces significantly when the gas phase is diluted (see the mean error). This effect is even clearer in the compressibility factor that reaches 0.9950, indicating that both models are equally suitable for the current problem. For simplicity, the ideal gas model was chosen for the next steps. With a simpler equation, it is possible to perform algebraic manipulations with greater versatility.

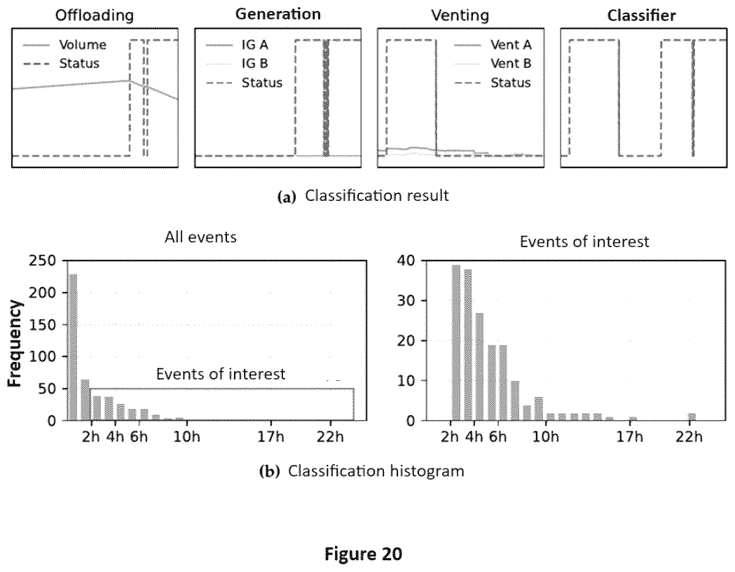

FIGS. 20 (a) and 20 (b) show results for the classification algorithm. Critical conditions are represented by the value 0, otherwise the operation is considered normal, as shown in FIG. 20 (a). In order to select the most promising periods for analysis, the classified data were ordered by duration and gathered in a histogram, as shown in FIG. 20 (b). All events lasting more than 2 h were selected for analysis, in order to maximize the chances of finding stable maneuvers in the oil flow, which is the ideal condition for building and validating the model.

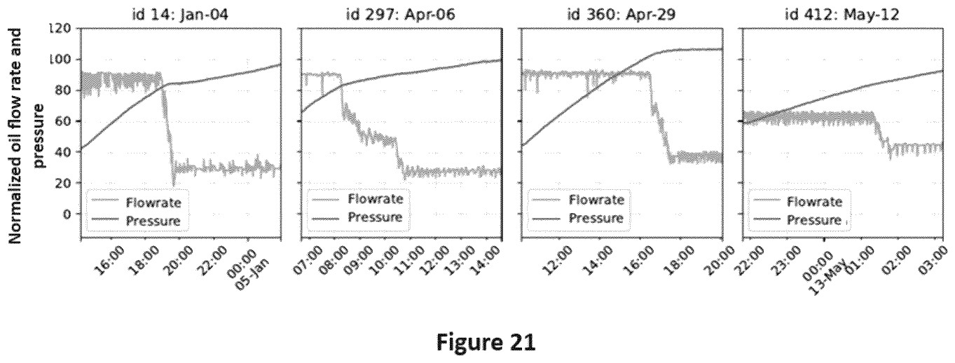

FIG. 21 illustrates the selection of an analysis period within a small set of critical periods obtained from the histogram in FIG. 20 (b).

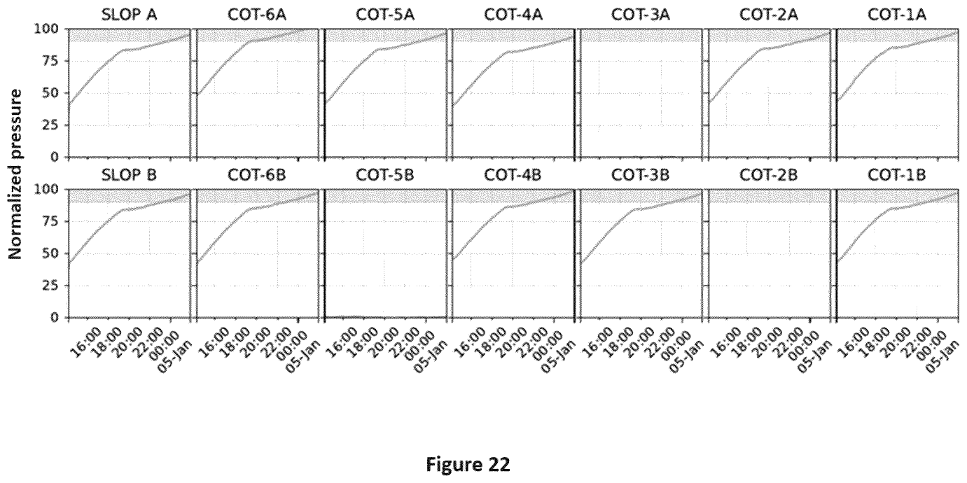

For each selected period, there is a careful analysis procedure that takes into account the particularities of the observed operational scenario. First, it is necessary to manually define which pressure, temperature and oil level sensors will be used to build the model. This is important to prevent faulty or inaccurate sensors from influencing the calculations. FIGS. 22, 23 and 24 show the procedure for selecting sensors for the case selected above.

According to FIG. 22, it can be seen that tanks 3BE, 5BB and 2BB show clearly biased pressure signals, since they are outside the expected range. Since the model uses the average pressure of the tanks at each sampling point, bad signals can bias the average and reduce the accuracy of the predictions.

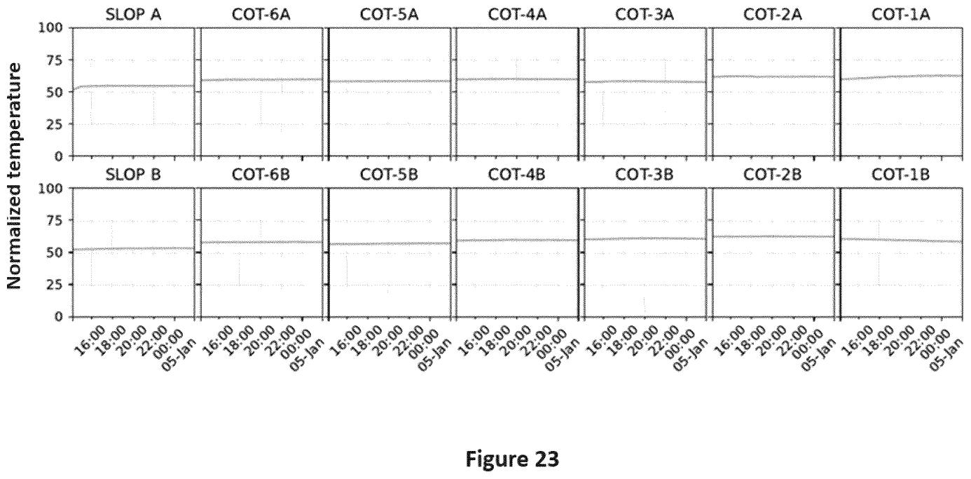

According to FIG. 23, no problems were found in the temperature data for the highlighted range, so all sensors are included in the average temperature calculations.

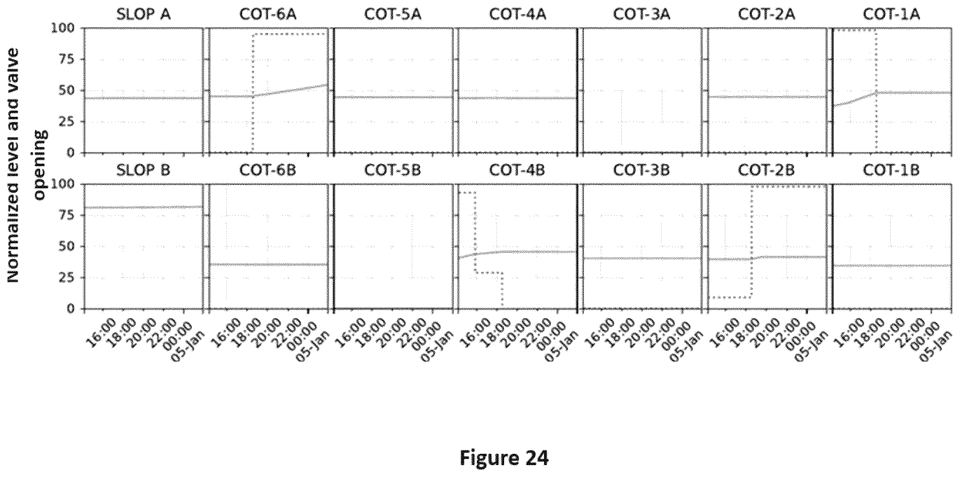

According to FIG. 24, the level sensors, on the other hand, require careful selection. The levels of tanks 3BE and 5BBB are zero, which corresponds to the full scale. This is an indication that the tank may be under maintenance and therefore completely isolated from the others. Level data are used to calculate the volume of the gas phase and an empty tank means that its entire volume is occupied by this phase. However, under maintenance conditions, the tank is isolated and therefore its volume is not occupied by the system gases. Including 3BE and 5BB tanks in the calculations could overestimate the current volume occupied by the gas phase and influence the vaporization and pressurization predictions.

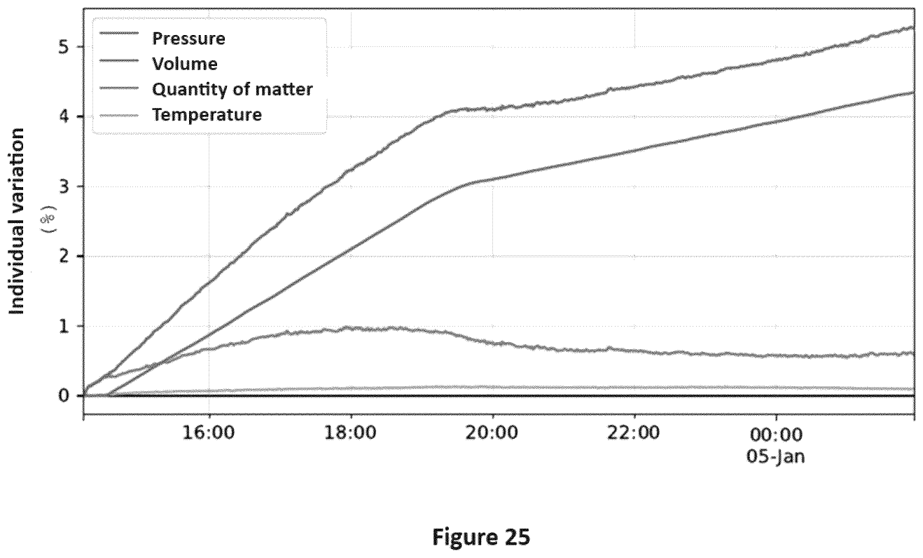

After careful selection of sensors, the gas phase is modeled. FIG. 25 shows a diagram of normalized contributions of each effect considered in the model. Each point on the diagram corresponds to a normalized sample with reference to the starting point of the analysis window. The pressure and temperature curves are the normalized averages of the measured signals. The volume curve is the result of the calculation performed with the level data. The amount of matter curve is the result of the model estimation. The normalization can be represented by equation 12 below.

$${x}_{norm} = \frac{x - {x}_{0}}{{x}_{0}} 100 \qquad equation 12$$

where x is the raw signal,
x₀ is the raw signal at the beginning of the analysis window, and
xₙₒᵣₘ is the normalized value expressed as a percentage change relative to the first point.

In practical terms, the ideal gas model links pressure variations directly to three effects: temperature, volume, and amount of matter. The contribution diagram shows each of these effects. Another important detail of the diagram is that the curves are marked according to the direction of the effect on pressure. In other words, the effects that increase pressure are represented by positive values, while the effects that reduce pressure are represented by negative values. It is important to note that the sum of the curves of these three variables results exactly in the pressure curve. And this is the main advantage of using this diagram: understanding the magnitude of each variable for the pressurization of the tanks. It is possible to clearly observe that the main factor responsible for pressurization is the contraction of the gaseous volume, characterized by a positive contribution of the volume in the diagram. On the other hand, the temperature has a negligible effect on pressurization over the period. All the remaining pressurization, which was not explained by either the volume or the temperature, has its cause attributed to the variation in the amount of matter in the medium. In FIG. 25 it is possible to note two stable operating zones, where the first has a higher pressurization rate than the second. This change in operation was caused by a reduction in the flow of oil produced. As can be seen, in addition to the expected effect of reducing the filling rate, there is also a significant effect of reducing the accumulation rate of the amount of matter. Any variation in the amount of matter can only be explained by the effects of vaporization and condensation of volatiles. Therefore, there is a relationship between the oil flow rate and the vaporization rate that needs to be modeled to correct possible operational simulations.

In order to model the vaporization rate, the derivatives of the amount of matter are calculated for each region of oil production. This procedure is repeated for all selected cases and the vaporization rates obtained are plotted against the average flow rate observed in the respective intervals, as shown in FIG. 8.

According to FIG. 8, at first glance, it is possible to notice the existence of a trend of higher vaporization rates for higher flow rates and lower rates for lower flow rates. However, there is a large dispersion of values, especially in the region of higher flow rates. Observing local trends, that is, data obtained within the same analysis interval, it is possible to notice two global behaviors that govern the relationship between the vaporization rate and the oil flow rate. The first behavior is characterized by a high derivative in the region of high vaporization rate and high oil flow rate. In this region, a strong reduction in the vaporization rate is observed due to the reduction in flow rate. The second behavior occurs in regions of low vaporization rate and covers the entire flow range, from high to low. It is very difficult, in this situation, to propose a single model capable of representing all the observed operational points. Therefore, the simplest way is to divide the model into two parts. Graphically, it is possible to draw a horizontal line, dividing the operation into two vaporization rate regions. The high rate regions will be represented by the high derivative model. The low rate regions will be represented by the low derivative model. Equations 8 and 9 below represent the vaporization models for each operational region.

$${r}_{vapH} = {a}_{H} {F}_{oil} + {b}_{H} \qquad equation 8$$

$${r}_{vapL} = {a}_{L} {F}_{oil} + {b}_{L} \qquad equation 9$$

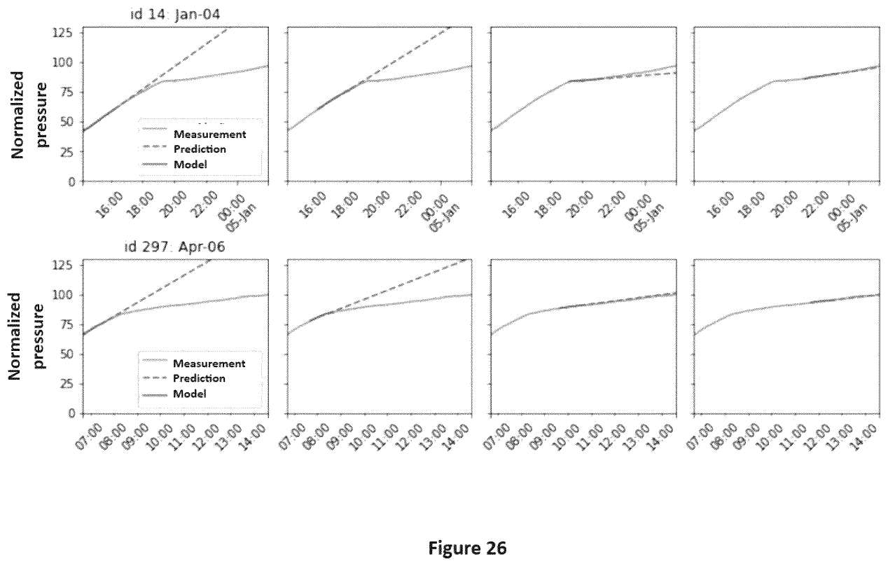

Model validation consists of imitating the scenario observed in the plant and evaluating the adequacy of the simulation to the measured data. FIGS. 10 and 11 show the validation result during two selected periods, where it is possible to observe excellent accuracy between the simulated trajectory and the data subsequently observed in the plant. These results provide great confidence that the system fulfills its main objective, which is to support the decision-making of the platform operations team. Another detail worth mentioning is the performance of the autoregressive model to predict pressurization, while maintaining the operating conditions. FIG. 26 illustrates how most of the selected cases in critical operation behave. Each column in FIG. 26 represents the temporal evolution of the model. Even in the presence of small deviations throughout the operation, the model has the ability to self-correct and remain adherent to the behavior of the plant.

In addition, the present disclosure relates to a computer-readable storage medium, which comprises, stored therein, a set of computer-readable instructions, in which when the set of computer-readable instructions is executed by one or more processors, the one or more processors implement the method for predicting the pressurization rate of oil tanks, described above.

In particular, the computer-readable storage media may be memory, where the memory may be a non-volatile memory such as a hard disk drive (HDD) or a solid-state drive (SSD), or it may be a volatile memory such as random-access memory (RAM). The computer-readable storage media may be any other medium that can carry or store the expected program code in the form of an instruction or a data structure or a set of instructions and can be accessed by a computer but is not limited to there. The computer-readable storage media may alternatively be a circuit or any other apparatus that can implement a storage function.

Specifically, the set of computer-readable instructions represents the algorithm or computer program code or a data structure that performs the method for predicting the pressurization rate of oil tanks described above.

The processor may be a general-purpose processor, which may be a microprocessor or any conventional processor or the like.

Those skilled in the art will appreciate the knowledge indicated herein and will be able to reproduce the disclosure in the embodiments shown and in other variants, covered by the scope of the appended claims.

1. A method for predicting the pressurization rate of an oil tank, the method comprising:
obtaining plant information data, wherein the plant information data comprises:
(a) data from at least one oil tank feed oil flow sensor,
(b) data from at least one oil tank liquid level sensor,
(c) data from at least one oil tank top pressure sensor, and
(d) data from at least one oil tank top temperature sensor;
classifying an operational period;
selecting a modeling data range;
determining a total volume of gas in the tank through data from an oil tank liquid level sensor;
determining an average pressure of the gas phase in the tank through the data from the oil tank top pressure sensor;
determining the average temperature of the gas phase in the tank through the data from the oil tank top temperature sensor;
setting the desired oil flow rate;
predicting future pressure in relation to the desired oil flow rate, by use of:
$${r}_{p} = \frac{{P}_{K} - {P}_{0}}{{t}_{k} - {t}_{0}}$$
where:
P_{K} is the pressure obtained at time t_{K},
P₀ is the pressure obtained at time to, which is prior to t_{K},
$${P}_{i} = \frac{{n}_{i} {RT}_{i}}{{V}_{i}} for i = 0 a K$$
Tᵢ is a temperature value and a linear function of the heating rate, equivalent to the temperature observed in the chosen time interval tₖ−t₀: d_{T}/dₜ=constant,
Vᵢ is a volume value and a linear function of the volume contraction rate, equivalent to the new specified oil flow rate: dᵥ/dₜ=−F_{simulated oil} and
nᵢ is the amount of matter and a linear function of the vaporization rate, which is a function of the oil flow rate: dₙ/dₜ=f(Fₒᵢₗ);
predicting the violation of the critical pressure;
determining a period of calm weather; and
defining a new oil production setpoint.

2. The method according to claim 1, wherein the plant information data further comprises one or more of:
data from at least one flow sensor or inert gas generation status data,
data from at least one flow sensor or windage status data, data from at least one flow sensor or oil offloading status data,
data from at least one wind speed sensor,
data from at least one wind direction sensor, or
data from at least one oil storage tank oil feed valve opening sensor.

3. The method according to claim 1, wherein classifying the operational period comprises verifying whether the following conditions are all simultaneously met:
there is no injection of inert gas into the oil tanks,
there is no of gases, and
there is no offloading (oil discharge from the tanks).

4. The method according to claim 1, wherein the total volume of gas in the tank is obtained by multiplying the data from the oil tank liquid level sensor by the area of the tank base.

5. The method according to claim 1, wherein the step of defining the desired oil flow rate is selected by a user.

6. The method according to claim 1, wherein the critical pressure value is configured by a user.

7. The method according to claim 1, wherein the critical pressure value is lower than the oil tank relief pressure.

8. The method according to claim 1, wherein the step of determining the period of calm weather comprises the user obtaining information about the duration of the calm weather.

9. The method according to claim 1, wherein the calm weather comprises winds with speeds lower than 3 knots.

10. The method according to claim 1, wherein during the period of calm weather, oil production is reduced.

11. A computer readable storage media comprising, stored therein, a set of computer-readable instructions, which when executed by a computer, executes the method as defined in one or more of the methods of claim 1.

12. A method for predicting the pressurization rate of an oil tank, the method comprising obtaining plant information data, classifying an operating period, selecting a modeling data range; determining total gas volume in the tank through data from an oil tank liquid level sensor, determining an average pressure of the gas phase in the tank through the data from the oil tank top pressure sensor, determining an average temperature of the gas phase in the tank through data from an oil tank top temperature sensor, setting the desired oil flow rate, predicting the future pressure in relation to the desired oil flow rate, predicting violation of the critical pressure, determining a period of time of weather calm, and setting a new oil production setpoint.
